(19) United States
(12) Patent Application Publication
(10) Pub. No.: US 2002/0094314 A1
(43) Pub. Date: Jul. 18, 2002

(54) Method for the reduction and removal of nitrogen oxides

(75) Inventors: Tatsuo Miyadera, Tsukuba-shi (JP); Yuji Ukisu, Tsukuba-shi (JP); Satoshi Kameoka, Tsukuba-shi (JP); Kimio Kunimori, Tsukuba-shi (JP)

Correspondence Address: LORUSSO & LOUD, 3137 Mt. Vernon Avenue, Alexandria, VA, 22305, US

(73) Assignee: NATIONAL INSTITUTE OF ADVANCED INDUSTRIAL SCIENCE AND TECHNOLOGY

(21) Appl. No.: 09/991,742

(22) Filed: Nov. 26, 2001

(30) Foreign Application Priority Data
Nov. 27, 2000 (JP) 2000-359162

(51) Int. Cl. B01D 53/56

(52) U.S. Cl. 423/239.1

(57) ABSTRACT

A method of removing nitrogen oxides from an exhaust gases by reducing the nitrogen oxides with an oxygen-containing compound in the presence of a catalyst containing an H-type ferrierite. The catalyst may include a metal ion and/or a metal compound or a third component such as alumina or silica.

### BACKGROUND OF THE INVENTION

The present invention relates to a method for the reduction and removal of nitrogen oxides and, more particularly, to a method for the reduction and removal of nitrogen oxides in a variety of combustion exhaust gases containing nitrogen oxides and in exhaust gases from industrial equipment.

Exhaust gases contain nitrogen oxides NOx (mixed gas of NO and NO₂) which cause photochemical smog and are hazardous to the human health. Therefore, procedures for treatment of NOx are being taken in a positive manner.

Reduction of NOx for removal from a large-size fixed combustion equipment such as boilers has been carried out on an industrial scale by means of the ammonia selective reduction method using ammonia as a reducing agent. Exhaust gases from gasoline vehicles are practically treated with a three-way catalyst.

Such a three-way catalyst, however, cannot be applied to exhaust gases from various internal combustion engines such as diesel engines, lean burn gasoline engines and lean burn gas engines because such exhaust gases contain oxygen in an amount larger than the stoichiometric amount required for the complete oxidation of unburned components in the exhaust gases.

Therefore, there have been proposed methods for removing NOx using hydrocarbons or an oxygen-containing compound such as methanol as a reducing agent, as the method for selectively reducing NOx contained in exhaust gases with oxygen left in an excessive amount.

The method for the reduction of NOx with such hydrocarbons, however, has still the problem that the rate of removal of NOx decreases, particularly when the reduction is carried out in the presence of moisture or SOx. Further, no catalyst has been yet developed which can overcome this problem when it is used on a commercial scale.

On the other hand, the method for the reduction of NOx with such an oxygen-containing compound does not cause any such problem and is a favorable method. Therefore, a number of catalysts suitable particularly for this method have been proposed. Such proposals include, for example, a catalyst with silver supported on alumina (Japanese Patent No. 2,516,145; Applied Catalysis B: Vol. 2, pp. 199-205 (1993)); a catalyst composed solely of a metal aluminate of a transition metal of the fourth period of the periodic table (Japanese Patent No. 2,547,124); a catalyst containing one or more members selected from proton zeolite, alumina, and a spinel-type metal aluminate of a transition metal of the fourth period of the periodic table with alumina (Japanese Patent No. 2,506,598).

### SUMMARY OF THE INVENTION

Therefore, the present invention has the object to provide a method for efficiently removing NOx from exhaust gases, which can efficiently decrease NOx from exhaust gases containing NOx in a wide range of temperature for treatment and without undergoing any influences from steam contained in such exhaust gases.

The present invention provides a method of treating a nitrogen oxides-containing waste gas, comprising contacting said exhaust gas with an oxygen-containing compound in the presence of a H-type ferrierite-containing catalyst to reduce the nitrogen oxide.

Other objects, features and advantages of the present invention will be apparent from the following description.

### DETAILED DESCRIPTION OF THE PREFERRED EMBODIMENTS OF THE INVENTION

A method of the present invention comprises contacting an NOx-containing exhaust gas with an oxygen-containing compound in the presence of a H-type ferrierite-containing catalyst to reduce the NOx.

Exhaust gases include, for example, any exhaust gases from vehicles, e.g., gasoline vehicles and diesel vehicles, engines, e.g., diesel engines and lean burn gas engines, power equipment, e.g., gas turbines, industrial equipment, e.g., boilers, heating furnaces and sintering furnaces; thermal power stations and waste incinerators.

Among those exhaust gases, the exhaust gases particularly suitable for the NOx-removing method according to the present invention may include NOx-containing exhaust gases that contain oxygen, in addition to NOx, in an amount greater than a stoichiometric amount required for the complete oxidation of gas components left unburned therein.

The amount of the nitrogen oxides, NOx, contained in such exhaust gases may appropriately vary with a composition of the exhaust gases. Typically, the exhaust gases may contain NOx in the range from 0.00001 to 10% by volume, preferably from 0.0001 to 1% by volume.

The exhaust gases for use with the present invention may generally contain other gas components in addition to NOx. Such gas components may typically include, for example, CO, H₂O, H₂, SOx, unburned hydrocarbons and unburned oxygen-containing compounds. More specifically, CO may typically be contained in an amount of 5% by volume or less; H₂O in an amount of 20% by volume or less; H₂ in an amount of 2% by volume or less; and SOx in an amount of 1% by volume or less. In this case, the presence of unburned hydrocarbons and/or unburned oxygen-containing compounds can work effectively for the reduction of NOx. Further, as a matter of course, inert gases such as nitrogen, carbon dioxide, etc. may also be contained in the exhaust gases.

As reductive gases for use with the present invention, there may be used the oxygen-containing compounds, and examples of such compounds include alcohols such as methanol, ethanol and propanol, ethers such as dimethyl ether, ethyl ether, propyl ether and methyl tertiary-butyl ether, esters, aldehydes, ketones and organic acids. Preferred oxygen-containing compounds include alcohols and ethers such as methanol and dimethyl ether. The oxygen-containing compounds may be used singly or in combination of two or more.

Although the amount of the oxygen-containing compound is not restricted to a particular one, it may be appropriate to be in the range of from 0.2-fold to 6-fold molar number, preferably from 0.5-fold to 3-fold molar number, when translated into carbon number with respect to NOx in exhaust gases.

The catalyst used for the present invention includes H-ferrierite (hereinafter referred to also as “H-FER”). Any H-ferrierite may be used for the present invention. The H-type ferrierite has a structure with H left therein and may be obtained by replacing cations in the ferrierite with ammonium ions by means of the ion exchange method and then removing NH₃ by calcination at approximately 300° C. The ferrierite referred to herein is a kind of zeolite and the crystal structure thereof belongs to a rhombohedral system in an ordinary state. Further, its space group is called Immm.

A typical chemical composition of a unit cell of the ferrierite may be represented by Na_{1.5}Mg₂[(Al₂O)_{5.5} (SiO₂)_{30.5}].18H₂O and the lattice constants of the ferrierite may be: a axis=1.92 nm, b axis=1.41 nm, and c axis=0.75 nm. As is well known to the art, zeolite is a non-stoichiometric compound and, therefore, the composition as referred to herein is variable. In an ordinary case, ferrierite having a SiO₂/Al₂O₃ molar ratio of approximately 10 to 70 is synthesized. The SiO₂/Al₂O₃ molar ratio of the thus synthesized ferririte can be increased without changing the structure by a chemical treatment to remove part of the aluminum. Further, at least part of the sodium ion and/or the magnesium ion in the above composition of the ferrierite may be replaced with other cations and such a substituted composition may also be used as ferrierite for use as a raw material for the present invention.

The H-type ferrierite-containing catalyst may be, for example, H-type ferrierite per se, a catalyst with a metal ion and/or a metal compound supported on the H-type ferrierite, a catalyst of the above type additionally containing a third component such as alumina, silica and titania.

It has been found that H-type ferrierite is effective by itself as a catalyst for reducing NOx. It has also been found that a catalyst with a metal ion and/or a metal compound supported on the H-type ferrierite or a H-type ferrierite catalyst with such a metal ion and/or a metal compound admixed with a third component such as alumina or silica can exhibit improved catalytic activity for reducing NOx and improved performance at a low temperature, as compared with the H-type ferrierite alone.

The metals of the metal ions and/or the metal compounds to be supported on the H-type ferrierite include, for example, iron, vanadium, chromium, manganese, cobalt, nickel, copper, zinc, gallium, molybdenum, ruthenium, rhodium, palladium, silver, tungsten, indium, tin, iridium and platinum. The metal compounds may be in the form of a metal salt including, for example, an oxide, a halide, a carbonate or a sulfate. Preferred species of the metal ions for use with the present invention may include, for example, iron, cobalt and silver, particularly preferred ones may include divalent iron ions and cobalt ions.

The H-type ferrierite catalyst with the metal ion and/or the metal compound supported thereon may be prepared by various methods known per se, for example, by supporting the metal ions and/or the metal compound on the H-type ferrierite by means of ion exchange method, impregnation method or solid ion exchange method and then subjecting the resulting product to a thermal treatment.

In the case of the ion exchange method, H-type ferrierite in a powdery state is suspended in water. The resulting suspension is then admixed with an aqueous solution containing a metal salt compound to be exchanged, and the mixture is stirred well into a uniform suspension. In this case, the ion exchange method may be carried out typically at room temperature or elevated temperature up to 95° C. The concentration of the metal salt compound is not restricted to a particular one and may be varied appropriately as needed.

In the case of the impregnation method, the catalyst may be prepared, for example, by impregnating an aqueous solution containing a metal salt compound in dry H-type ferrierite.

The catalyst with the metal species supported thereon prepared by the ion exchange method or the impregnation method may preferably be calcined in air.

In the case of the solid ion exchange method, the catalyst may be prepared, for example, by mixing powders of a metal oxide, a metal salt compound or the like with powders of the H-type ferrierite to a sufficient extent and then calcining the resulting mixture in air. The calcining temperature in this case may typically range from approximately 300° C. to 550° C.

The metals or the metal compounds may be in the form of an ion, an oxide, a halide or a salt, as it is present in the H-type ferrierite.

In the catalyst thus calcined, the metal species is present in the form of an ion when supported by the ion exchange method, in the form of an oxide or a salt when supported by the impregnation method or in the form of an ion or a salt when supported by means of the solid ion exchange method. As a matter of course, however, the structure of the catalyst is not restricted to those described above.

It is possible to support two or more metal species on H-type ferrierite. Examples of combinations include iron ions and cobalt ions, tungsten oxide and molybdenum oxide, tungsten oxide and vanadium oxide, and iron ions and tungsten oxide.

The amount of the metal species on the H-type ferrierite may range 0.001 to 20% by weight, preferably 0.002% to 10% by weight, in terms of the metal elements.

The catalyst may be practically used for treatment of exhaust gases in any desired form such as pellet, honeycomb, grid, plate or column. In this case, the catalyst by itself may be formed in such a desired form. Alternatively, the catalyst may be coated on a previously shaped substrate of, for example, cordierite by any suitable method such as by wash coat method. Further, the catalyst may be formed by synthesizing ferrierite directly on a previously shaped substrate and introducing the metal species thereinto.

When the catalyst itself is shaped into a desired form, it is preferred to use a binder such as alumina sol, silica sol, bentonite, clay or polyvinyl alcohol. The use of an alumina sol or silica sol binder which serves as a source of alumina or silica is preferred, because the NOx-reducing efficiency of the catalyst is improved as will be described hereinafter.

The reduction of NOx in the exhaust gases may be carried out by placing the catalyst in a reactor and passing NOx-containing exhaust gases therethrough in the presence of an oxygen-containing compound.

The oxygen-containing compound may be added to the exhaust gases at a position upstream of the catalyst layer and reacted with NOx on the catalyst at generally 200-700° C., preferably 250-600° C., at 0.5-2 atmospheric pressure in a standard state.

If the concentration of unburned hydrocarbons and unburned oxygen-containing compounds in the exhaust gases is high, the amount of the oxygen-containing compound such as methanol and/or dimethyl ether may be decreased.

The following examples will further illustrate the present invention.

### PREPARATION EXAMPLE

Preparation of H-type Ferrierite Molded Body

4 Grams of H-type ferrierite powders (SiO₂/Al₂O₃=17.9 (molar ratio); hereinafter referred to as H-FER powders) were mixed with 1.20 g of polyvinyl alcohol, and 8.0 g of water was added. The mixture was kneaded and molded into a column form. The molding was dried at 90° C. for 3 hours and pulverized into powders. The powders were then dried at 110° C, for 2 hours and then calcined. The calcination was performed by heating the powders to 550° C. through 10 hours, followed by maintenance at 550° C. for 8 hours in air. After calcination, the resulting powders were sieved to yield powders having particle sizes ranging from 0.25-2.0 mm for use in a test. The calcination could remove polyvinyl alcohol leaving only H-type ferrierite. The resulting product will be referred to as H-FER(100).

### Example 1

A reaction tube was filled with 9.5 ml of H-FER(100) catalyst prepared above. A model flue gas prepared by adding water in an amount of 10% to the composition consisting of 1,000 ppm of NO, 2,000 ppm of methanol, 10% of 02 and a balance of He were passed through the reaction tube at a space velocity of 12,800 per hour. The concentration of NO and NOx in the reactive gases was measured with a NO/NOx analyzer of a chemilluminescence type. The removal rate of NOx (inlet NOx concentration−corrected outlet NOx concentration)/inlet NOx concentration) is shown in Table 1. The “corrected outlet NOx concentration” means a concentration of NOx obtained by compensating a portion of NO₂ dissolved and lost in a drain water (condensed water resulting at the time of cooling).

### Example 2

To 3 g of H-FER powders was added alumina sol (trade name: “Cataloid AS-3”; product of Catalysts and Chemicals Co.) as a binder, and the mixture was admixed well, followed by molding the mixture into a column form. The product was then dried at room temperature for 3 hours and then at 110° C. for 2 hours. Thereafter, the temperature was raised to 550° C. through 10 hours and then maintained at 550° C. for 8 hours in air. After calcination, the resulting product was pulverized and sieved to yield powders having particle sizes of 0.25-2.0 mm for use in a test. The amount of the binder (alumina) in the resulting product was approximately 20% by weight. Using 9.5 ml of the thus prepared catalyst (hereinafter referred to as H-FER(80)), a test was performed under the same conditions as Example 1. The results are shown in Table 1 below.

### Example 3

To 3 g of the H-FER powders was added 32.7 g of alumina sol (“Cataloid AS-3”) as used in Example 2 as a binder, and the mixture was admixed well, followed by drying at 90° C. until the water content was reduced to an appropriate level and then molded into a column form. The molded product was further dried at room temperature for 3 hours and then at 110° C. for another 2 hours, followed by raising the temperature to 550° C. through 10 hours and calcination at 550° C. for 8 hours in air. After calcination, the product was pulverized into powders and sieved to yield powders having particle sizes of 0.25-2.0 mm for use in a test. The amount of the binder (alumina) in the resulting product was found to be approximately 50% by weight. Using 9.5 ml of the catalyst (hereinafter referred to as H-FER(50)) as prepared above, a test was performed under the same conditions as Example 1. The results are shown in Table 1 below.

### Example 4

To 3 g of the H-FER powders were added 3.4 g of silica sol (“Cataloid S-20L”; product of Catalysts and Chemicals Co.) and 3.0 ml of water, and the mixture was admixed well, followed by molding into a column form. The molded product was dried at room temperature for 3 hours and then at 110° C. for another 2 hours, followed by raising the temperature to 550° C. through 10 hours and calcination at 550° C. for 8 hours in air. After calcination, the product was pulverized into powders and sieved to yield powders having particle sizes of 0.25-2.0 mm for use in a test. The amount of the binder (silica) in the resulting powders was found to be approximately 20% by weight. Using 9.5 ml of the thus prepared catalyst (hereinafter referred to as H-FER(silica)), a test was performed under the same conditions as Example 1. The results are shown in Table 1 below.

### Example 5

Nitrogen gas was bubbled through 350 ml of water at a rate of 100 ml per minute for 1 hour. While continuing the bubbling, 2.62 g of FeSO₄.7H₂O was dissolved in the water to produce a solution A. Separately, 150 ml of water was bubbled for 1 hour by feeding nitrogen gas at the flow rate of 100 ml per minute and 4 g of H-FER powders was fed to the solution while continuing the bubbling, thereby producing a suspension B. Then, the suspension B was poured into the solution A while continuing the bubbling with nitrogen gas. The mixture was stirred for 20 hours at 50° C. under nitrogen atmosphere to conduct ion exchange with Fe⁺² ions. Then, the sample was separated by filtration and washed twelve times with distilled water. Thereafter, the product was dried at 110° C. for 2 hours and heated to 500° C. through 5 hours, followed by calcining at 500° C. for 8 hours in air. The amount of Fe⁺² ions supported on the product was found to be 0.03% by weight. To the total amount of the resulting H-type ferrierite powders with Fe⁺² ions supported thereon was added 10.3 g of alumina sol (trade name: “Cataloid AS-3”) used in Example 3 as a binder, and the product was molded into a column form. The resulting product was dried at room temperature for 3 hours and then at 110° C. for another 2 hours, followed by heating to 500° C. through 10 hours and calcination at 500° C. for 8 hours in air. After calcination, the product was pulverized and sieved to yield powders having particle sizes ranging from 0.25 mm to 2.0 mm for use in a test. The amount of the binder (alumina) in the final product was found to be approximately 20% by weight. Using 9.5 ml of the thus prepared catalyst (hereinafter referred to also as “Fe(II)-H-FER”), a test was performed under the same conditions as in Example 1 and the results are shown in Table 1 below.

### Example 6

A solution (solution A) was prepared by dissolving 2.35 g of Co(CH₃COO)₂.4H₂O in 350 ml of water. Separately, a suspension (suspension B) was prepared by feeding 4 g of the H-FER powders to 150 ml of water. The solution A was admixed with the suspension B and the resulting mixture was subjected to ion exchange with Co⁺² ions while maintaining at 60° C. for 20 hours while stirring. Then, the mixture was separated by filtration and washed twelve times with distilled water. Thereafter, the product was dried at 110° C. for 2 hours and the temperature was raised to 500° C. through 5 hours, followed by calcination the resulting product at 500° C. for 8 hours in air. The amount of Co⁺² supported on the product was found to be 1.1% by weight. To the total amount of the resulting H-type ferrierite powders with Co⁺² ions deposited thereon was added 10.3 g of alumina sol (trade name: “Cataloid AS-3”) used in Example 2 as a binder, followed by molding it into a column form. The molded column-shaped product was dried at room temperature for 3 hours and then at 110° C. for another 2 hours, and the temperature was raised to 500° C. through 10 hours. The molded product was then calcined at 500° C. for 8 hours in air. After calcination, the product was pulverized and sieved to yield powders having particle sizes in the range of from 0.25-2.0 mm for use in a test. The amount of the binder (alumina) in the final product was found to be approximately 20% by weight. Using 9.5 ml of the thus prepared catalyst (hereinafter referred to as “Co-H-FER”), a test was performed under the same conditions as in Example 1 and the results are shown in Table 1 below.

### Example 7

A solution (solution A) was prepared by dissolving 0.64 gram of silver nitrate in 350 ml of water. A suspension (suspension B) was prepared by feeding 4 g of the H-FER powders to 150 ml of water. The solution A was admixed with the suspension B and the resulting mixture was subjected to ion exchange with Ag⁺¹ ions while covering the reactor with aluminum foil to shield light and maintaining it at 80° C. for 20 hours while stirring. Then, the mixture was separated by filtration and washed twelve times with distilled water. Thereafter, the product was dried at 110° C. for 2 hours and the temperature was raised to 500° C. through 5 hours, followed by calcination at 500° C. for 8 hours in air. The amount of Ag supported on the product was found to be 0.6% by weight. To the total amount of the resulting H-type ferrierite powders with Ag⁺¹ ions supported thereon in the above manner was added 10.3 g of alumina sol (trade name: “Cataloid AS-3”) used in Example 2 as a binder, followed by molding it into a column form. The molded column-shaped product was then dried at room temperature for 3 hours and at 110° C. for another 2 hours, and the temperature was raised to 500° C. through 10 hours. The molded product was then calcined at 500° C. for 8 hours in air. After calcination, the product was pulverized into powders and sieved yielding powders having particle sizes ranging from 0.25-2.0 mm for use in a test. The amount of the binder (alumina) in the final product was found to be approximately 20% by weight. Using 9.5 ml of the thus prepared catalyst (hereinafter referred to as “Ag-H-FER”), test was performed under the same conditions as in Example 1 and the results are shown in Table 1 below.

### Example 8

A solution was prepared by dissolving 0.09 gram of silver nitrate in 8 ml of water. To the resulting solution was added 3 g of H-FER powders. The resulting solution was dried with stirring to almost dryness and then dried at 110° C. for 2 hours and the temperature was raised to 500° C. through 10 hours, followed by calcination at 500° C. for 8 hours in air. The amount of Ag supported on the product was found to be 2.0% by weight. To the total amount of the resulting H-type ferrierite powders with silver nitrate supported thereon in the above manner was added 8.4 g of alumina sol (trade name: “Cataloid AS-3”) used in Example 2 as a binder, followed by molding into a column form. The molded column-shaped product was then dried at room temperature for 3 hours and then at 110° C. for another 2 hours, and the temperature was raised to 500° C. through 8 hours. The molded product was then calcined at 500° C. for 8 hours in air. After calcination, the product was pulverized into powders and sieved yielding powders having a particle size of 0.25-2.0 mm for use in a test. The amount of the binder (alumina) in the final product was found to be approximately 20% by weight. Using 9.5 ml of the thus prepared catalyst (hereinafter referred to also as “Ag/H-FER”), a test was performed under the same conditions as in Example 1 and the results are shown in Table 1 below.

### Example 9

A solution (solution A) was prepared by dissolving 1.36 gram of an aqueous rhodium nitrate solution (Rh: 7.45% by weight) to 350 ml of water. A suspension (suspension B) was prepared by feeding 4 g of the H-FER powders to 150 ml of water. The solution A was admixed with the suspension B and the resulting mixture was subjected to ion exchange with Rh⁺³ ions while maintaining it at 60° C. for 20 hours while stirring. Then, the mixture was separated by filtration and washed twelve times with distilled water. Thereafter, the product was dried at 110° C. for 2 hours and the temperature was raised to 500° C. through 5 hours, followed by calcination at 500° C. for 8 hours in air. The amount of Rh supported on the product was found to be 0.4% by weight. To the total amount of the resulting H-type ferrierite powders with Rh⁺³ ions supported thereon in the above manner was added 10.3 g of alumina sol (trade name: “Cataloid AS-3”) used in Example 2 as a binder, followed by molding it into a column form. The molded column-shaped product was then dried at room temperature for 3 hours and at 110° C. for 2 hours, and the temperature was raised to 500° C. through 10 hours. The molded product was then calcined at 500° C. for 8 hours in air. After calcination, the product was pulverized into powders and sieved yielding powders having a particle size of 0.25-2.0 mm for use in a test. The amount of the binder (alumina) in the final product was found to be approximately 20% by weight. Using 9.5 ml of the thus obtained catalyst (hereinafter referred to as “Rh-H-FER”), a test was performed under the same conditions as in Example 1 and the results are shown in Table 1 below.

### Example 10

A suspension was prepared by suspending 1.34 gram of vanadium pentaoxide in 20 g of water and heating the resulting mixture on water bath at 70° C. The resulting suspension was stirred while stepwise adding 3.5 g of oxalic acid dihydrate thereto. After the addition of oxalic acid, the temperature of the suspension was raised to 90° C. and stirred for about 30 minutes to dissolve vanadium pentaoxide therein. During stirring, water was added in an appropriate amount for replenishing the portion of water decreased on account of evaporation. The aqueous vanadium solution prepared in the above manner was collected in the amount of 0.82 gram, to which 7.3 g of water was added. To the resulting solution was added 3 g of the H-FER powders, and the resulting mixture was dried to almost dryness while stirring at room temperature. The product was further dried at 110° C. for 2 hours and the temperature was raised to 500° C. through 10 hours. Then, the product was calcined at 500° C. for 8 hours in air. The amount of vanadium supported thereon was found to be 1.0% by weight when translated into V. To the total amount of the H-type ferrierite powders with vanadium supported thereon as prepared in the above manner was added 8.4 g of alumina sol (trade name: “Cataloid AS-3”) as used in Example 2, and the resulting product was molded into a column form. The molded product was dried at room temperature for 3 hours and then at 110° C. for 2 hours. Thereafter, the temperature of the molded product was raised to 500° C. over the time of 10 hours, and the product was calcined at 500° C. for 8 hours in air. After calcination, the product was pulverized into powders and sieved yielding powders having particle sizes in the range of 0.25-2.0 mm for use in a test. The amount of the binder (alumina) in the final product was found to be approximately 20% by weight. Using 9.5 ml of the thus prepared catalyst (hereinafter referred to as “V/H-FER”) prepared in the above manner, a test was performed under the same manners as in Example 1 and the results are shown in Table 1 below.

### Example 11

A solution was prepared by dissolving 0.22 gram of ammonium tungstate para-pentahydrate and 0.11 gram of oxalic acid dihydrate in 8 ml of water. To the resulting solution was fed 3 g of the H-FER powders. The mixture was dried to almost dryness while stirring at room temperature and then at 110° C. for 2 hours. Thereafter, the temperature of the mixture was raised to 500° C. through 10 hours and the mixture was calcined at 500° C. for 8 hours in air. The amount of tungsten supported was found to be 5.0% by weight when translated into W. To the total amount of the H-type ferrierite with tungsten supported thereon as prepared in the above manner was added 8.4 g of alumina sol (trade name: “Cataloid AS-3”) as used in Example 2 as a binder, and the resulting product was molded into a column form. The column-shaped molded product was dried at room temperature for 3 hours and then at 110° C. for 2 hours. Thereafter, the temperature of the molded product was raised to 550° C. through 10 hours, and the product was calcined at 500° C. for 8 hours in air. After calcination, the product was pulverized and sieved yielding powders having particle sizes in the range of 0.25-2.0 mm for use in a test. The amount of the binder (alumina) in the final product was found to be approximately 20% by weight. Using 9.5 ml of the thus prepared catalyst (hereinafter referred to as “W/H-FER”) prepared in the above manner, a test was performed under the same manners as in Example 1 and the results are shown in Table 1 below.

### Example 12

A gas consisting of 500 ppm of NO, 500 ppm of dimethyl ether, 10% 02 and a balance of He, to which water was added in an amount of 10%, was passed through a reaction tube packed with 9.5 ml of the H-FER(100) catalyst prepared in the above Preparation Example at a space velocity of 12,800 per hour. The rate of removal of NOx measured in substantially the same manner as in Example 1 is shown in Table 2 below.

### Example 13

Example 12 was repeated in the same manner as described using 9.5 ml of the H-FER(80) catalyst as prepared in Example 2. The test results are shown in Table 2.

### Example 14

Example 12 was repeated in the same manner as described using 9.5 ml of the Fe(II)-FER catalyst as prepared in Example 5. The test results are shown in Table 2.

### Example 15

Example 12 was repeated in the same manner as described using 9.5 ml of the Co-H-FER catalyst as prepared in Example 6. The test results are shown in Table 2.

### Comparative Example 1

A total amount of 12 g of Na-type ZSM-5 powders (SiO₂/Al₂O₃=23.8 (molar ratio); product of TOSO Co.) was washed with deionized water, and the resulting powders were poured in 500 ml of a solution prepared by dissolving 12 g of ammonium nitrate in water. The resulting mixture was held at 95° C. for 24 hours while stirring with a stirrer to allow an ion exchange with ammonium ions. Then, the sample was allowed to cool and then separated by filtration, followed by washing the sample eight times with distilled water. A set of the processes including the ion exchange, filtering and washing processes was repeated three times as a whole, and the sample was dried at 110° C. for 2 hours. The temperature of the sample was raised to 300° C. through 2 hours and the sample was calcined at 300° C. for 12 hours in air to convert ZSM-5 to the H-type. To 5 g of the H-type ZSM-5 was added 14 g of the alumina sol (“Cataloid AS-3”) as used in Example 2, and the mixture was molded into a column form. The molded product was then dried at room temperature for 3 hours and at 110° C. for another 2 hours, followed by raising the temperature to 550° C. through 10 hours and calcination the product at 550° C. for 8 hours in air. After calcination, the product was pulverized into powders and sieved yielding powders having a particle size of 0.25-2.0 mm for use in a test. The amount of the binder (alumina) in the final product was found to be approximately 20% by weight. Using 9.5 ml of the thus obtained catalyst (hereinafter referred to as “H-ZSM-5”), the test was performed under the same conditions as in Example 1 and the results are shown in Table 1 below.

### Comparative Example 2

A total amount of 70 g of alumina sol (“Cataloid AS-3”) was dried at 90° C. for about 2 hours to reduce the water content and then molded into a column form. The column-shaped molded product was then dried at room temperature for 3 hours and at 110° C. for another 2 hours, followed by raising the temperature to 550° C. through 10 hours. Then, the molded product was calcined at 550° C. for 8 hours in air. After calcination, the product was pulverized into powders and sieved yielding powders having a particle size of 0.25-20 mm. Using 9.5 ml of the thus obtained catalyst (represented by Al₂O₃), the test was performed under the same conditions as in Example 1 and the results are shown in Table 1 below.

### Comparative Example 3

A total amount of 9.5 ml of alumina (particle size: 0.25-2.0 mm) prepared in the same manner as in Comparative Example 2 was poured into a solution prepared by dissolving 0.85 gram of Co(CH₃COO)₂.4H₂O in 9.5 ml of water. After the mixture was allowed to stand for 1 hour while shaking, alumina was separated from the solution and dried at 110° C. for 2 hours and the temperature was raised to 600° C. over the time of 10 hours, followed by calcination the alumina at 600° C. for 8 hours in air. The amount of cobalt deposited was found to be 2.0% by weight as Co. Using the total amount of the product (hereinafter referred to as “Co/Al₂O₃”) as a catalyst, the test was carried out under the same conditions as in Example 1. The results are shown in Table 1.

### Comparative Example 4

A solution (solution A) was prepared by dissolving 1.74 g of Co(CH₃COO)₂.4H₂O in 350 ml of water. Separately, a suspension (suspension B) was prepared by pouring 4 g of H-type beta-zeolite (H-BEA, SiO₂/Al₂O₃=27.3 (molar ratio); product of TOSO Co.) powders (calcined at 500° C. for 5 hours and cooled in air before use) into 150 ml of water. The suspension B was mixed with the solution A, and the mixture was subjected to ion exchange with Co⁺² ions while holding the suspension at 60° C. for 20 hours while stirring. After the ion exchange process, the sample was separated by filtration and washed twelve times with distilled water. Thereafter, the product was dried at 110° C. for 2 hours and then the temperature was raised to 500° C. through 5 hours, followed by calcination at 500° C. for 8 hours in air. The amount of supported cobalt was found to be 0.9% by weight when translated into Co. To the total amount of the H-type beta-zeolite powders with Co⁺² ions supported thereon in the above manner was added 10.6 g of alumina sol (“Cataloid AS-3”), and the product was molded into a column form. The column-shaped molded product was dried at room temperature for 3 hours and then at 110° C. for another 2 hours, followed by raising the temperature to 500° C. through 10 hours and calcination at 500° C. for 8 hours. After calcination, the resulting product was pulverized into powders and sieved yielding powers having a particle size of 0.25-2.0 mm for use in a test. Using 9.5 ml of the thus obtained catalyst (hereinafter referred to as “Co-H-BEA”), the test was carried out under the same conditions as in Example 1. The results are shown in Table 1 below.

### Comparative Example 5

Example 12 was repeated in the same manner as described using 9.5 ml of the H-ZSM-5 catalyst as prepared in Comparative Example 1. The results are shown in Table 2.

### Comparative Example 6

Example 12 was repeated in the same manner as described using 9.5 ml of the Al₂O₃ catalyst as prepared in Comparative Example 2. The results are shown in Table 2.

Table 1 shows the results of the test in which gases containing 1,000 ppm of NO, 2,000 ppm of methanol and 10% O₂ and He as balance, to which water was added in an amount of 10%, were supplied at a space velocity of 12,800 per hour (Examples 1-11 and Comparative Examples 1-4). Table 2 below shows the results of the test in which gases having the composition of 500 ppm of NO, 500 ppm of dimethyl ether and 10% O₂ and He as balance, to which water was added at the rate of 10%, were supplied at a space velocity of 12,800 per hour (Examples 12-15 and Comparative Examples 5-6).

TABLE 1

| | | Temperature (° C.) | | | | | | |
|---|---|---|---|---|---|---|---|---|
| | | 250 | 300 | 350 | 400 | 450 | 500 | 550 |
| | Catalyst | NOx Removal Rate (%) | | | | | | |
| Exam- | H-FER(100) | | 14.7 | 29.4 | 65.6 | 95.1 | 94.9 | 87.2 |
| ple 1 | | | | | | | | |
| Exam- | H-FER(80) | | 18.7 | 41.3 | 97.4 | 98.7 | 96.0 | 77.3 |
| ple 2 | | | | | | | | |
| Exam- | H-FER(50) | | 28.2 | 74.3 | 98.3 | 96.8 | 86.4 | 64.9 |
| ple 3 | | | | | | | | |
| Exam- | H- | | 18.3 | 29.8 | 63.9 | 96.0 | 94.6 | 79.1 |
| ple 4 | FER(silica) | | | | | | | |
| Exam- | Fe(II)-H- | 17.5 | 52.6 | 93.6 | 98.5 | 95.7 | 85.9 | |
| ple 5 | FER | | | | | | | |
| Exam- | Co-H-FER | 45.3 | 86.9 | 96.1 | 96.4 | 87.1 | 70.0 | |
| ple 6 | | | | | | | | |
| Exam- | Ag-H-FER | 16.1 | 71.3 | 63.5 | 39.0 | 25.8 | 18.9 | |
| ple 7 | | | | | | | | |
| Exam- | Ag/H-FER | 13.8 | 59.8 | 83.8 | 61.3 | 46.3 | 37.1 | |
| ple 8 | | | | | | | | |
| Exam- | Rh-H-FER | 16.4 | 49.7 | 72.2 | 18.3 | 11.0 | 10.8 | |
| ple 9 | | | | | | | | |
| Exam- | V/H-FER | 25.1 | 62.7 | 73.7 | 68.7 | 53.3 | 35.7 | |
| ple 10 | | | | | | | | |
| Exam- | W/H-FER | | | 28.4 | 82.6 | 97.0 | 96.1 | 84.9 |
| ple 11 | | | | | | | | |
| Com- | H-ZSM-5 | | 19.8 | 39.9 | 71.3 | 82.3 | 65.7 | 27.6 |
| par- | | | | | | | | |
| ative | | | | | | | | |
| Exam- | | | | | | | | |
| ple 1 | | | | | | | | |
| Com- | Al₂O₃ | | 9.7 | 35.6 | 54.4 | 46.4 | 32.3 | 19.8 |
| par- | | | | | | | | |
| ative | | | | | | | | |
| Exam- | | | | | | | | |
| ple 2 | | | | | | | | |
| Com- | Co/Al₂O₃ | | 44.7 | 59.3 | 35.6 | 20.1 | 9.7 | |
| par- | | | | | | | | |
| ative | | | | | | | | |
| Exam- | | | | | | | | |
| ple 3 | | | | | | | | |
| Com- | Co-H-BEA | 3.7 | 5.9 | 2.4 | 3.2 | 6.3 | 8.5 | |
| par- | | | | | | | | |
| ative | | | | | | | | |
| Exam- | | | | | | | | |
| ple 4 | | | | | | | | |

TABLE 2

| | | Temperature (° C.) | | | | | |
|---|---|---|---|---|---|---|---|
| | | 250 | 300 | 350 | 400 | 450 | 500 |
| | Catalyst | NOx Removal Rate (%) | | | | | |
| Example 12 | H-FER(100) | | 25.6 | 49.4 | 73.8 | 40.6 | 28.3 |
| Example 13 | H-FER(80) | | 37.4 | 87.1 | 86.4 | 38.7 | 26.5 |
| Example 14 | Fe(II)-H-FER | 19.1 | 65.6 | 95.3 | 60.3 | 32.0 | 23.1 |
| Example 15 | Co-H-FER | 45.7 | 79.7 | 92.7 | 46.9 | 29.1 | 22.9 |
| Compara- | H-ZSM-5 | | 22.7 | 37.2 | 41.2 | 8.7 | 6.2 |
| tive | | | | | | | |
| Example 5 | | | | | | | |
| Compara- | Al₂O₃ | | 4.5 | 15.4 | 48.8 | 23.1 | 13.4 |
| tive | | | | | | | |
| Example 6 | | | | | | | |

The present invention can efficiently remove NOx contained in exhaust gases containing oxygen in the amount larger than a stoichiometric amount with respect of combustible components including, for example, carbon monoxide, hydrogen and hydrocarbon in a temperature range as wide as from 250° C. to 550° C. without undergoing any influence from steam.

The entire disclosure of Japanese Patent Application No. 2000-359,162 filed on Nov. 27, 2000, including the specification and claims is hereby incorporated by reference herein.

What is claimed is:

1. A method of treating a nitrogen oxides-containing waste gas, comprising contacting said exhaust gas with an oxygen-containing compound in the presence of a H-type ferrierite-containing catalyst to reduce the nitrogen oxides.

2. The method as claimed in claim 1, wherein said H-type ferrierite-containing catalyst contains metal ions and/or a metal compound supported thereon.

3. The method as claimed in claim 1, wherein said H-type ferrierite-containing catalyst contains alumina or silica.

4. The method as claimed in claim 2, wherein said H-type ferrierite-containing catalyst contains alumina or silica.

5. The method as claimed in claim 1, wherein said oxygen-containing compound is an alcohol or an ether.

6. The method as claimed in claim 5, wherein said alcohol is methanol.

7. The method as claimed in claim 5, wherein said ether is dimethyl ether.

8. The method as claimed in claim 1, wherein said exhaust gas contains nitrogen oxides in an amount of from 0.00001 to 10% by volume.

9. The method as claimed in claim 1, wherein said exhaust gas further contains carbon monoxide in an amount of 5% by volume or less, moisture in an amount of 20% by volume or less, hydrogen in an amount of 2% by volume or less, and SOx in an amount of 1% by volume or less.

10. The method as claimed in claim 1, wherein said oxygen-containing compound is used in an amount of from 0.2-fold to 5-fold mole number with respect to the nitrogen oxides contained in said exhaust gas, when translated into carbon number.

11. The method as claimed in claim 1, wherein said metal ions supported on said H-type ferrierite in an amount of 0.1% by weight to 20% by weight, when translated into the metal elements.

12. The method as claimed in claim 1, wherein said catalyst is in a pellet form, in a honeycomb form, in a lattice form, in a plate form, or in a column form.

13. The method as claimed in claim 1, wherein said contacting is performed at temperature ranging from 200° C. to 700° C. and pressure ranging from 0.5 to 2 atmospheric pressure.
